(19) United States
(12) Patent Application Publication
(10) Pub. No.: US 2017/0072653 A1
(43) Pub. Date: Mar. 16, 2017

(54) Void Cells With Outwardly Curved Surfaces

(71) Applicant: Skydex Technologies, Inc., Centennial, CO (US)

(72) Inventors: Jerod Dahl, Centennial, CO (US); Peter Foley, Castle Rock, CO (US); Thomas Christopher Manney, Bennett, CO (US)

(21) Appl. No.: 15/225,154

(22) Filed: Aug. 1, 2016

Related U.S. Application Data
(60) Provisional application No. 62/219,451, filed on Sep. 16, 2015.

(51) Int. Cl. B29D 99/00; A41D 13/015; B32B 37/12; A47C 7/02; B65D 81/02; B29C 65/48; A43B 7/32; A47C 27/06

(52) U.S. Cl. CPC B29D 99/0092; A43B 7/32; A41D 13/015; A47C 27/064; A47C 7/021; B65D 81/022; B29C 65/48; B32B 37/12; B29L 2031/751

(57) ABSTRACT

Implementations described and claimed herein include a cushioning material layer and method for manufacturing a cushioning material layer, which allows for maximum comfort through the compression and shock cycle. Specifically, a cushioning material layer comprises void cells formed in an array, which comprise multiple outwardly facing curvatures, with varying radius measurements. Stiffness in the void cells can vary by varying the radiuses. The outwardly facing curvatures prevent buckling and provide support for high impact by absorbing energy.

### BACKGROUND

Cushioning systems are used in a wide variety of applications including comfort and impact protection of the human body. A cushioning system is placed adjacent a portion of the body and provides a barrier between the body and one or more objects that would otherwise impinge on the body. For example, a pocketed spring mattress contains an array of close-coupled metal springs that cushion the body from a bed frame. Similarly, footwear, chairs, gloves, knee-pads, helmets, etc. may each include a cushioning system that provides a barrier between a portion of the body and one or more objects.

A variety of structures are used for cushioning systems. For example, an array of close-coupled, closed-cell air and/or water chambers often constitutes air and water mattresses. An array of close-coupled springs often constitutes a conventional mattress. Further examples include open or closed cell foam and elastomeric honeycomb structures.

For cushioning systems utilizing an array of closed or open cells or springs, either the cells or springs are directly coupled together or one or more unifying layers are used to couple each of the cells or springs together at their extremities. Directly coupling the cells or springs together or indirectly coupling the extremities of the cells or springs together is effective in tying the cushioning system together.

### SUMMARY

Implementations described and claimed herein include a cushioning material layer and method for manufacturing a cushioning material layer, which allows for maximum comfort through the compression and shock cycle. Specifically, a cushioning material layer comprises mutated void cells formed in an array, which comprise of multiple outwardly facing curvatures of varying radius measurements. Stiffness in the void cells can be manipulated by varying the radiuses. The outwardly facing curvatures prevent buckling and provide support for high impact by absorbing energy.

Other implementations are also described and recited herein.

### BRIEF DESCRIPTION OF THE DRAWINGS

FIG. 1 illustrates a perspective view of an example cellular cushioning system in an unloaded state.

FIG. 2 illustrates a top view of an example void cell in one array of the example cellular cushioning system in FIG. 1.

FIG. 3 illustrates an elevation view of the example cellular cushioning system in FIG. 1.

FIG. 4 illustrates a top view of the example cellular cushioning system in FIG. 1.

FIG. 5 illustrates a perspective view of an example cellular cushioning system in an unloaded state.

FIG. 6 illustrates an elevation view of the example cellular cushioning system in FIG. 5.

FIG. 7 illustrates a top view of the example cellular cushioning system in FIG. 5.

FIG. 8 illustrates a perspective view of an example cellular cushioning system in an unloaded state.

FIG. 9 illustrates an elevation view of the example cellular cushioning system in FIG. 8.

FIG. 10 illustrates a top view of the example cellular cushioning system in FIG. 8.

FIG. 11 illustrates a perspective view of an example cellular cushioning system in an unloaded state.

FIG. 12 illustrates an elevation view of the example cellular cushioning system in FIG. 11.

FIG. 13 illustrates a top view of the example cellular cushioning system in FIG. 11.

FIG. 14 illustrates a perspective view of an example cellular cushioning system in an unloaded state.

FIG. 15 illustrates an elevation view of the example cellular cushioning system in FIG. 14.

FIG. 16 illustrates a top view of the example cellular cushioning system in FIG. 14.

FIG. 17 illustrates a perspective view of an example cellular cushioning system in an unloaded state.

FIG. 18 illustrates an elevation view of the example cellular cushioning system in FIG. 17.

FIG. 19 illustrates a top view of the example cellular cushioning system in FIG. 17.

FIG. 20 illustrates a perspective view of an example cellular cushioning system in an unloaded state.

FIG. 21 illustrates an elevation view of the example cellular cushioning system in FIG. 20.

FIG. 22 illustrates a top view of the example cellular cushioning system in FIG. 20.

FIG. 23 shows a graph of force displacement of void cells in arrays of the described cushioning systems.

FIG. 24 shows a table of load force based on 10%, 25%, 50%, and 75% compression for the void cells in arrays of the described cushioning systems.

FIG. 25 illustrates example operations of manufacturing an example cellular cushioning system.

### DETAILED DESCRIPTIONS

The disclosed technology includes a cushioning material layer, which allows for maximum comfort through the compression and shock cycle. Specifically, a cushioning material layer comprises of mutated void cells formed in an array or a sheet, which comprise of multiple outwardly facing curvatures, with varying radius measurements. The elastic modulus or stiffness in the void cells can be manipulated by varying the number, the depths, and the locations (e.g., vertical height) of the radiuses in the void cells. The outwardly facing curvatures prevent buckling and provide support for high impact by absorbing energy. The void cells in the disclosed technology can withstand over 3,000 compressions without significant degradation.

Void cells without curvatures can experience buckling and loss of support in void cells during impact. The void cells without curvature can displace too rapidly and not absorb as much energy with curvature. Therefore, it is beneficial to have a configuration that does not endure stress concentrations within the material itself (e.g., folds that might create a crack over time or create a significant decrease in force deflection performance over time).

The disclosed technology can be used in a variety of comfort-impact-protection and pressure-distribution cushioning applications, including, but not limited to: footwear, mattresses, furniture cushioning, body padding, and packaging. In one implementation, the void cells comprising multiple outwardly facing curvatures can support footwear capable of withstanding threes times a user's body weight during use.

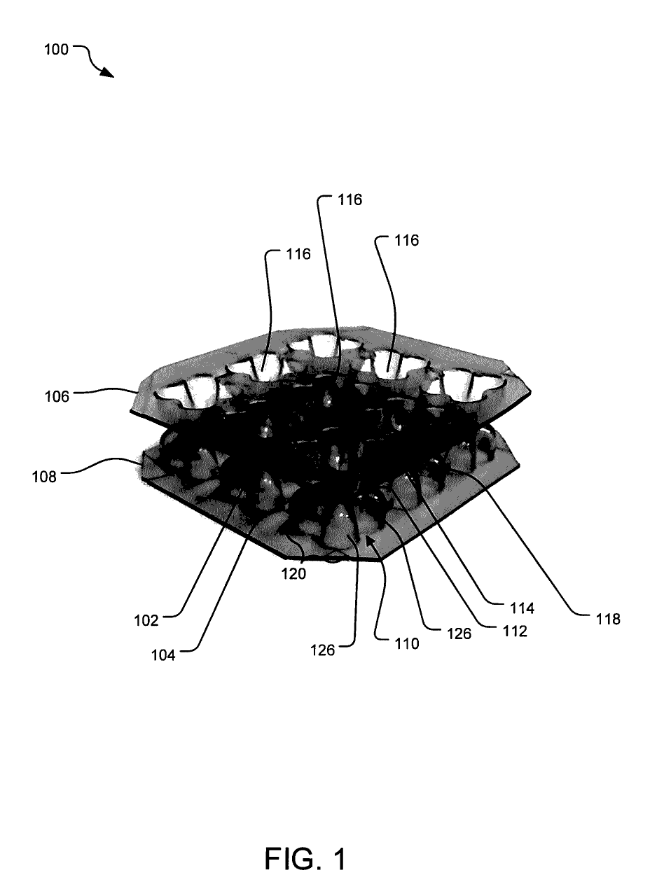

FIG. 1 illustrates a perspective view of an example cellular cushioning system 100 in an unloaded state. The cellular cushioning system 100 includes void cells (e.g., void cell 102 or void cell 104) arranged in two arrays. In other implementations, there can be one or more than two arrays of void cells. The arrays can be flat or curved.

For purposes of this disclosure, the two arrays in FIG. 1 are a top array 106 and a bottom array 108. However, in another implementation, the top array and bottom array could be referred to as right side and left side arrays, first and second arrays, bottom and top arrays, or other named features depending on desired terminology or configurations.

In FIG. 1, the top array 106 and the bottom array 108 have void cells (e.g., void cell 104), which comprise of four outwardly facing curvatures (e.g., curvature 110), each outwardly facing curvature in each sidewall (e.g., sidewall 120) of each void cell (e.g., void cell 104) in the top array 106 and the bottom array 108 in the cellular cushioning system 100. Each void cell (e.g., void cell 104) also comprise of eight inwardly facing curvatures (e.g., curvature 126), wherein two inwardly facing curvatures are each sidewall (e.g., sidewall 120) of each void cell.

In other implementations, there can be two, three, or more curvatures in each void cell. In some implementations, there may be more than one curvature in a sidewall of a void cell. For example, there may be a wave of curvatures in the sidewalls (e.g., about 12 oscillations yielding a very stiff cell). In other implementations, there may be no curvatures in one or more sidewalls.

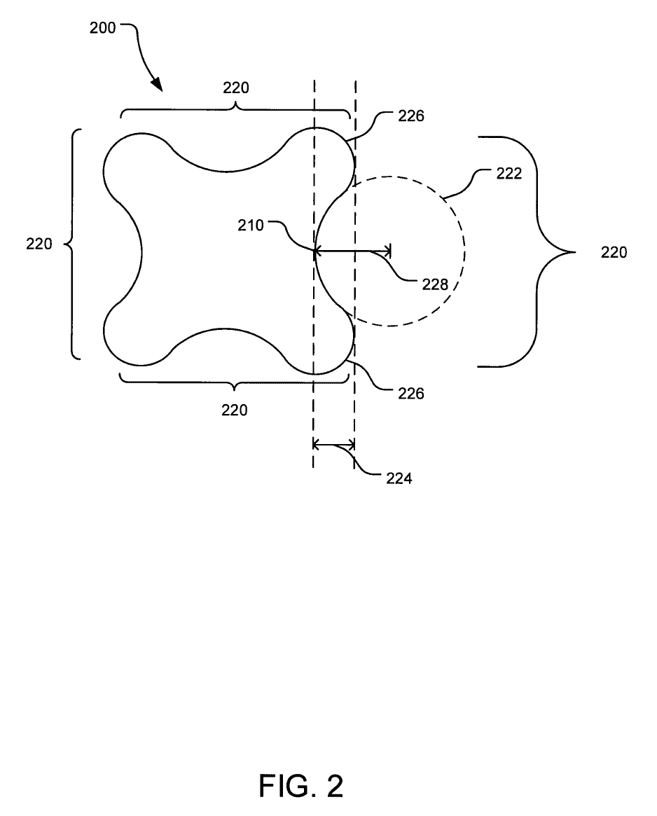

Different numbers and patterns of outwardly facing curvatures (e.g., curvature 110) can be molded into the void cells (e.g., void cell 104) in an array. In some implementations, a cubic shape of a void cell (e.g., void cell 102) may adopt the slope of its twin cubic shape of an adjacent or adjoined void cell (e.g., void cell 104). In the cellular cushioning system 100, the peak or bottom (e.g., peak 112) of the void cell (e.g., void cell 104) can be significantly rounded or segmented as a result of a larger radius or of a deeper depth of each curvature (e.g., curvature 110), or by the number of curvatures present in each void cell. (The radiuses and depths of the curvatures are described in detail in FIG. 2.)

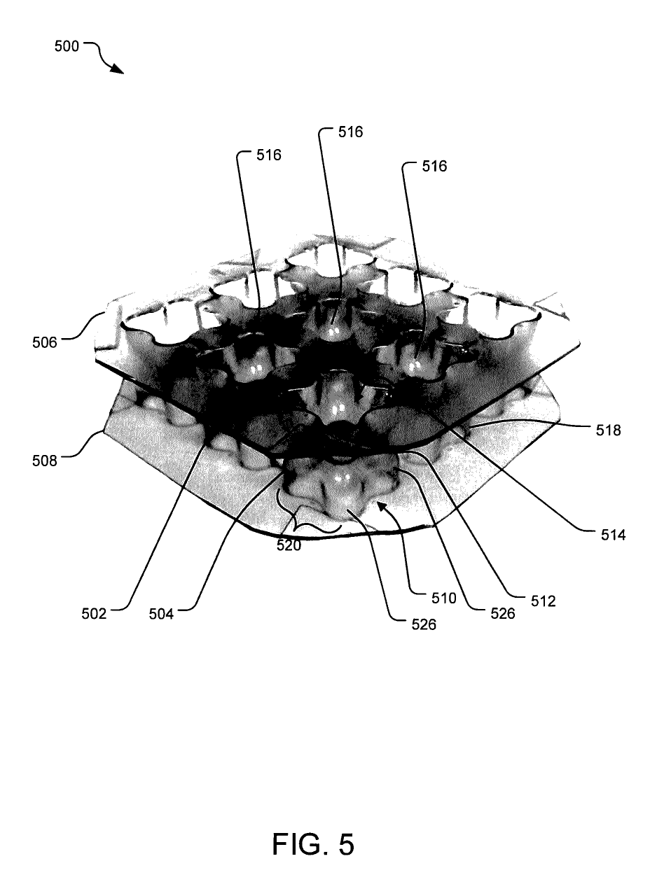

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 5 and 11-13). Cross sections of curvatures in the walls of a void cell may vary from a minimal indention, as minimally required to break the line running from the tangent from one corner of the void cell to the next corner of the void cell, to as great as an ellipse, which extends into the void cell by half its width. Similarly, the opening or top (e.g., opening 114) of the void cell can vary in shape as a result of a smaller radius or of a shallower depth of each curvature, or by the number of curvatures present in each voids cell.

In other implementations, curvatures can be molded only near the planar surface, partially up a void cell, or close to an interface between adjacent void cells. Stiffness can be varied depending on the molding of these different patterns.

The cellular cushioning system 100 may be manufactured using a variety of manufacturing processes (e.g., blow molding, thermoforming, extrusion, injection molding, laminating, etc.). In one implementation, the system 100 is manufactured by forming two separate arrays, a top array 106 and a bottom array 108. The two arrays are then laminated, glued, or otherwise attached together at the peaks or bottom surfaces of the void cells in the top array 106 and the bottom array 108. For example, the peaks of the void cells (e.g., peak 112 of void cell 104) of the top array 106 are attached to the peaks (e.g., peak of void cell 102 (not shown)) of the void cells of the bottom array 108.

The void cells are hollow chambers that resist deflection due to compressive forces, similar to compression springs.

At least the material, wall thickness, size, and shape of each of the void cells define the resistive force each of the void cells can apply. Materials used for the void cells are generally elastically deformable under expected load conditions and will withstand numerous deformations without fracturing or suffering other breakdown impairing the function of the cellular cushioning system 100. Example materials include thermoplastic urethane, thermoplastic elastomers, styrenic co-polymers, rubber, Dow Pellethane®, Lubrizol Estane®, Dupont™ Hytrel®, ATOFINA Pebax®, and Krayton polymers. Further, the wall thickness may range from 5 mil to 160 mil. Still further, the size of each of the void cells may range from 5 mm to 70 mm sides in a cubical implementation. Further yet, the void cells may be cubical, pyramidal, hemispherical, or any other shape capable of having a hollow interior volume. Other shapes may have similar dimensions as the aforementioned cubical implementation. Still further, the void cells may be spaced a variety of distances from one another. An example spacing range is 2.5 mm to 150 mm.

In one implementation, the void cells have a square or rectangular base shape, with a trapezoidal volume and a rounded top. That void cell geometry may provide a smooth compression profile of the system 100 and minimal bunching of the individual void cells. Bunching occurs particularly on corners and vertical sidewalls of the void cells where the material buckles in such a way as to create multiple folds of material that can cause pressure points and a less uniform feel to the cellular cushioning system overall.

The material, wall thickness, cell size, and/or cell spacing of the cells within the cellular cushioning system 100 may be optimized to minimize generation of mechanical noise by compression (e.g., buckling of the sidewalls) of the void cells. For example, properties of the cells may be optimized to provide a smooth relationship between displacement and an applied force. Further, a light lubricating coating (e.g., talcum powder or oil) may be used on the exterior of the void cells to reduce or eliminate noise generated by void cells contacting and moving relative to one another. Reduction or elimination of mechanical noise may make use of the cellular cushioning system 100 more pleasurable to the user.

Each void cell can be surrounded by neighboring void cells within an array. For example, void cell 102 is surrounded by three neighboring void cells 116 within the top array 106. In cellular cushioning system 100, there are three neighboring void cells for each corner void cell, five neighboring void cells for each edge cell, and eight neighboring void cells for the center void cell. Other implementations may have greater or fewer neighboring void cells for each void cell.

Further, in implementations where an array has an opposite array, each void cell may have a corresponding opposing void cell within the opposite array. For example, void cell 102 in the top array 106 is opposed by void cell 104 in the bottom array 108. Other implementations do not include opposing void cells for some or all of the void cells. Still further, each void cell has corresponding neighbor opposing cells within an opposite array. For example, void cell 102 in the top array 106 has a corresponding neighbor opposing cell 118 in the bottom array 108. The neighbor opposing cells are opposing void cells for each neighboring void cell of a particular void cell.

The neighboring void cells, opposing void cells, and neighbor opposing void cells are collectively referred to herein as adjacent void cells. In various implementations, one or more of the neighboring void cells, opposing void cells, and opposing neighbor void cells are not substantially compressed within an independent compression range of an individual void cell.

In one implementation, the void cells are filled with ambient air. In another implementation, the void cells are filled with a foam or a fluid other than air. The foam or certain fluids may be used to insulate a user's body, facilitate heat transfer from the user's body to/from the cellular cushioning system 100, and/or affect the resistance to deflection of the cellular cushioning system 100. In a vacuum or near-vacuum environment (e.g., outer space), the hollow chambers may be un-filled.

Further, the void cells may have one or more apertures or holes (not shown) through which air or other fluid may pass freely when the void cells are compressed and de-compressed. By not relying on air pressure for resistance to deflection, the void cells can achieve a relatively constant resistance force to deformation. Still further, the void cells may be open to one another (i.e., fluidly connected) via passages (not shown) through the array. The holes and/or passages may also be used to circulate fluid for heating or cooling purposes. For example, the holes and/or passages may define a path through the cellular cushioning system 100 in which a heating or cooling fluid enters the cellular cushioning system 100, follows a path through the cellular cushioning system 100, and exits the cellular cushioning system 100. The holes and/or passages may also control the rate at which air may enter, move within, and/or exit the cellular cushioning system 100. For example, for heavy loads that are applied quickly, the holes and/or passages may restrict how fast air may exit or move within the cellular cushioning system 100, thereby providing additional cushioning to the user.

The holes may be placed on mating surfaces of opposing void cells on the cellular cushioning system 100 to facilitate cleaning. More specifically, water and/or air could be forced through the holes in the opposing void cells to flush out contaminants. In an implementation where each of the void cells is connected via passages, water and/or air could be introduced at one end of the cellular cushioning system 100 and flushed laterally through the cellular cushioning system 100 to the opposite end to flush out contaminants. Further, the cellular cushioning system 100 could be treated with an anti-microbial substance or the cellular cushioning system 100 material itself may be anti-microbial.

FIG. 2 illustrates a top view of an example void cell 200 in one array of the example cellular cushioning system in FIG. 1. The void cell 200 is cube-shaped with four sidewalls 220. The four sidewalls 220 each have one outwardly facing curvature (curvature 210) and two inwardly facing curvatures (curvatures 226).

In other implementations, there can be two, three, or more curvatures in each void cell. In some implementations, there may be more than one curvature in a sidewall of a void cell. For example, there may be a wave of curvatures in the sidewalls (e.g., about 12 oscillations yielding a very stiff cell). In other implementations, there may be no curvatures in one or more sidewalls.

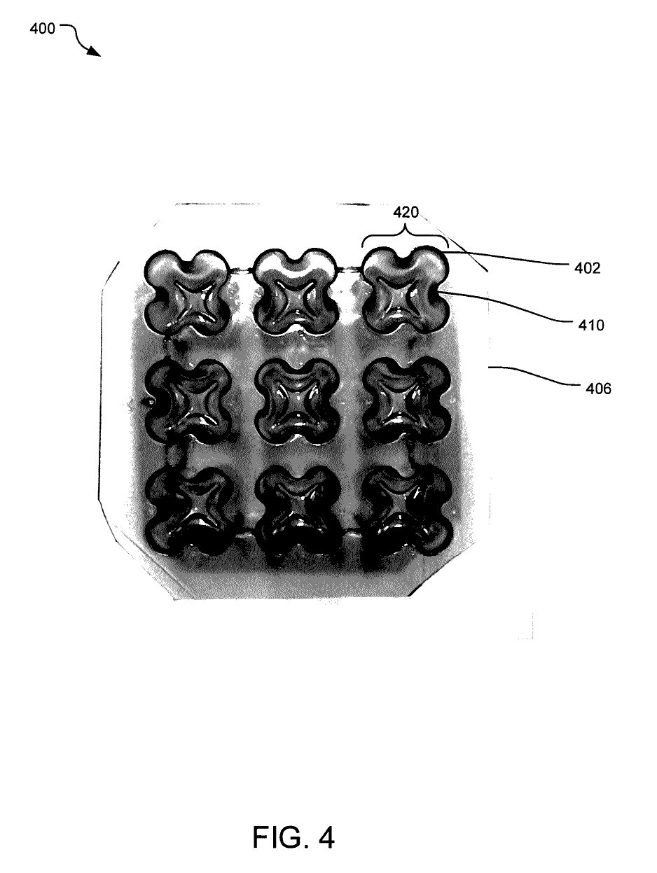

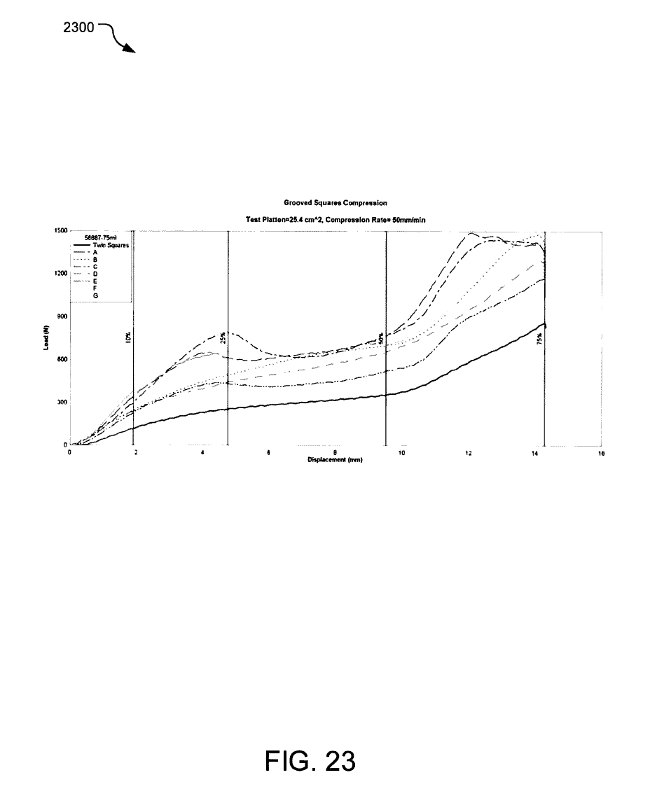

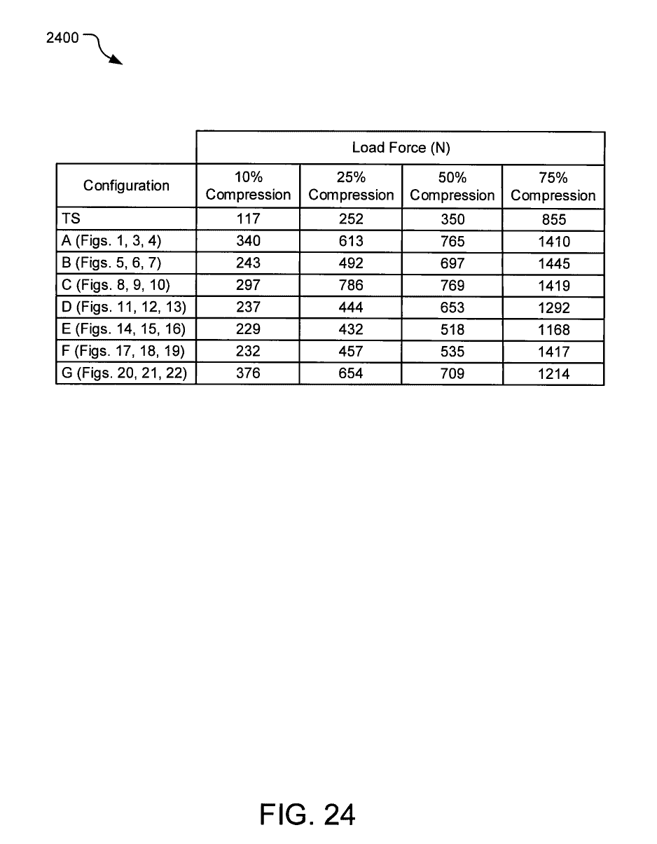

A circle 222 can be projected from each outwardly facing curvature 210, each outwardly facing curvature 210 having a characteristic radius 226 and a characteristic depth 224. Radius and depth of each curvature may vary from the characteristic radius and depth (e.g. vary 10% or less). The size of the radiuses and the depths of the curvatures can vary in different implementations and in the same void cell. For instance, FIGS. 4, 7, and 10 show three void cells with the same geometry except for outward facing radius of different magnitude. Each void cell has the same number of outward facing radii per side but by varying the magnitude of the radii in each void cell, the structures deflect very differently, as shown in FIGS. 23 and 24 in Configurations A, D, and C, respectively.

The elastic modulus or stiffness in the void cells can be manipulated by varying the number, the depths, and the locations (e.g., vertical height) of the radiuses in the void cells. The outwardly facing curvatures prevent buckling and provide support for high impact by absorbing energy.

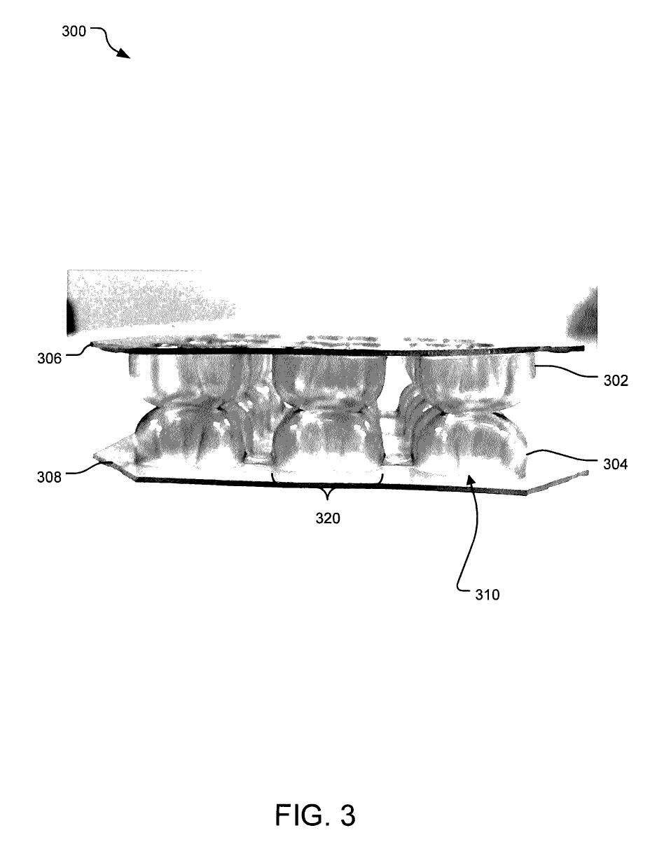

FIG. 3 illustrates an elevation view of the example cellular cushioning system in FIG. 1. The cellular cushioning system 300 includes void cells (e.g., void cell 302 or void cell 304) arranged in a top array 306 and a bottom array 308.

In FIG. 3, the top array 306 and the bottom array 308 have void cells (e.g., void cell 304), which comprise of four outwardly facing curvatures (e.g., curvature 310) in each sidewall 320 of each void cell in the top array 306 and the bottom array 308 in the cellular cushioning system 300.

FIG. 4 illustrates a top view of the example cellular cushioning system in FIG. 1. As shown, the cellular cushioning system 400 includes void cells (e.g., void cell 402) arranged in a top array 406 and a bottom array 408 (not shown).

FIG. 4 shows the top array 406 has void cells (e.g., void cell 402), which comprise of four outwardly facing curvatures (e.g., curvature 410) in each sidewall 420 of each void cell in the top array 406 in the cellular cushioning system 400.

FIG. 5 illustrates a perspective view of an example cellular cushioning system 500 in an unloaded state. The cellular cushioning system 500 includes void cells (e.g., void cell 502 or void cell 504) arranged in two arrays. In other implementations, there can be one or more than two arrays of void cells.

For purposes of this disclosure, the two arrays in FIG. 5 are a top array 506 and a bottom array 508. However, in another implementation, the top array and bottom array could be referred to as right side and left side arrays, first and second arrays, bottom and top arrays, or other named features depending on desired terminology or configurations.

In FIG. 5, the top array 506 and the bottom array 508 have void cells (e.g., void cell 504), which comprise of four outwardly facing curvatures (e.g., curvature 510) in each sidewall (e.g., sidewall 520) of each void cell (e.g., void cell 504) in the top array 506 and the bottom array 508 in the cellular cushioning system 500. Each void cell (e.g., void cell 504) also comprise of eight inwardly facing curvatures (e.g., curvature 526), wherein two inwardly facing curvatures are each sidewall (e.g., sidewall 520) of each void cell.

In other implementations, there can be two, three, or more curvatures in each void cell. In some implementations, there may be more than one curvature in a sidewall of a void cell. In other implementations, there may be no curvature in one or more sidewalls.

Different numbers and patterns of outwardly facing curvatures (e.g., curvature 510) can be molded into the void cells (e.g., void cell 504) in an array. In some implementations, a square shape of a void cell (e.g., void cell 502) may adopt the slope of its twin square shape of an adjacent or adjoined void cell (e.g., void cell 504). In the cellular cushioning system 500, the peak or bottom (e.g., peak 512) of the void cell (e.g., void cell 504) can be significantly rounded or segmented as a result of a larger radius or of a deeper depth of each curvature (e.g., curvature 510), or by the number of curvatures present in each void cell.

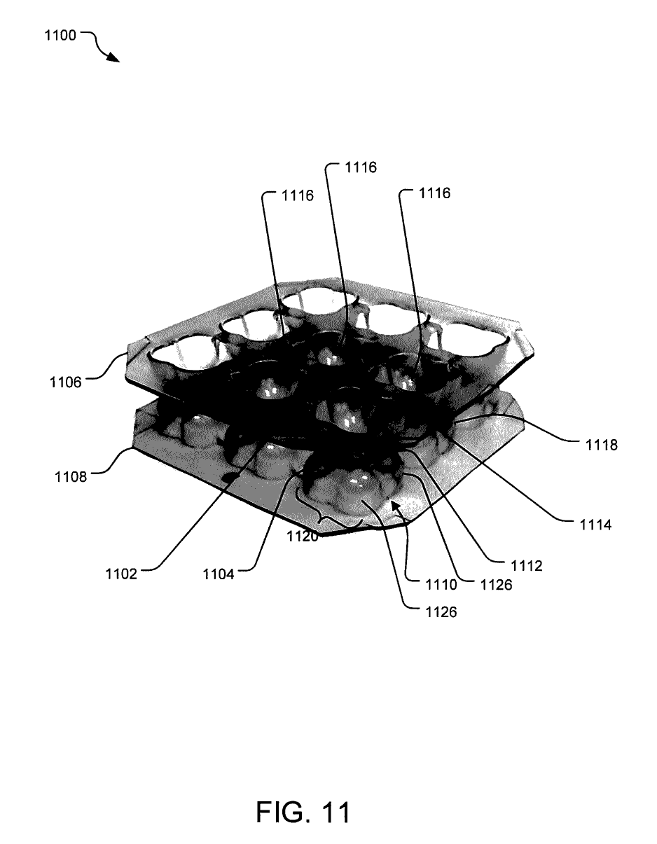

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 11-13). Similarly, the opening or top (e.g., opening 514) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. Stiffness can be varied depending on the molding of these different patterns.

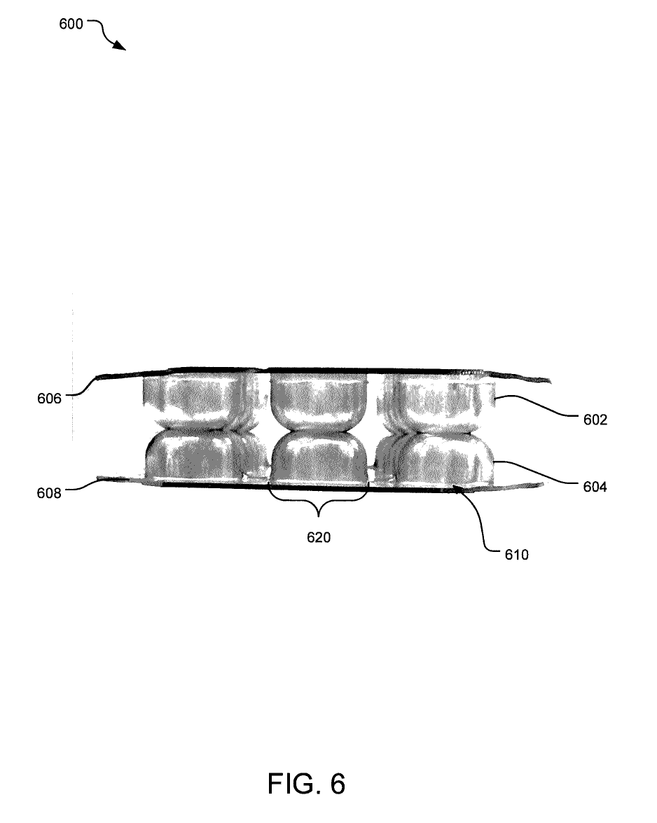

FIG. 6 illustrates an elevation view of the example cellular cushioning system in FIG. 1. The cellular cushioning system 600 includes void cells (e.g., void cell 602 or void cell 604) arranged in a top array 606 and a bottom array 608.

In FIG. 6, the top array 606 and the bottom array 608 have void cells (e.g., void cell 604), which comprise of four outwardly facing curvatures (e.g., curvature 610) in each sidewall 620 of each void cell in the top array 606 and the bottom array 608 in the cellular cushioning system 600.

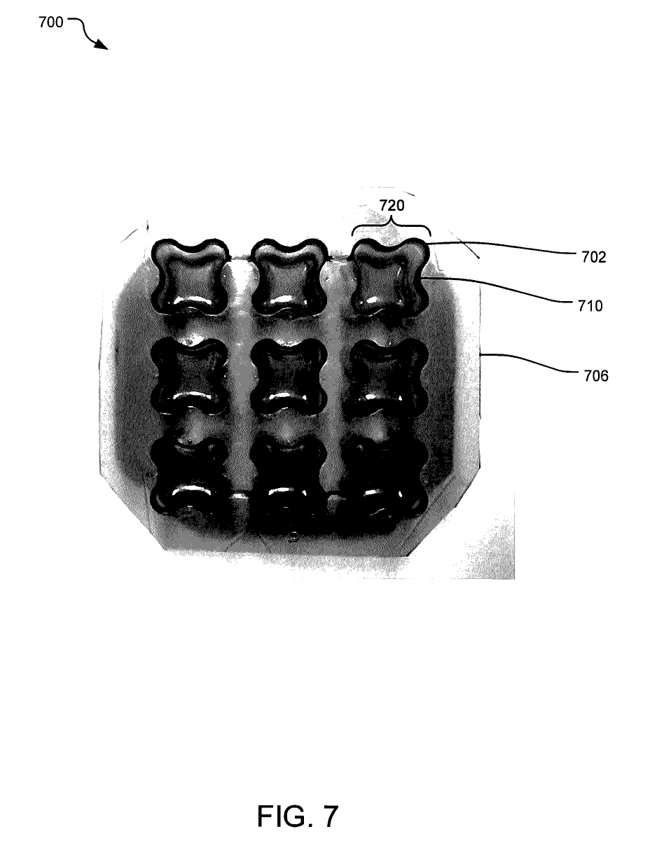

FIG. 7 illustrates a top view of the example cellular cushioning system in FIG. 1. As shown, the cellular cushioning system 700 includes void cells (e.g., void cell 702) arranged in a top array 706 and a bottom array 708 (not shown).

FIG. 7 shows the top array 706 has void cells (e.g., void cell 702), which comprise of four outwardly facing curvatures (e.g., curvature 710) in each sidewall 720 of each void cell in the top array 706 in the cellular cushioning system 700.

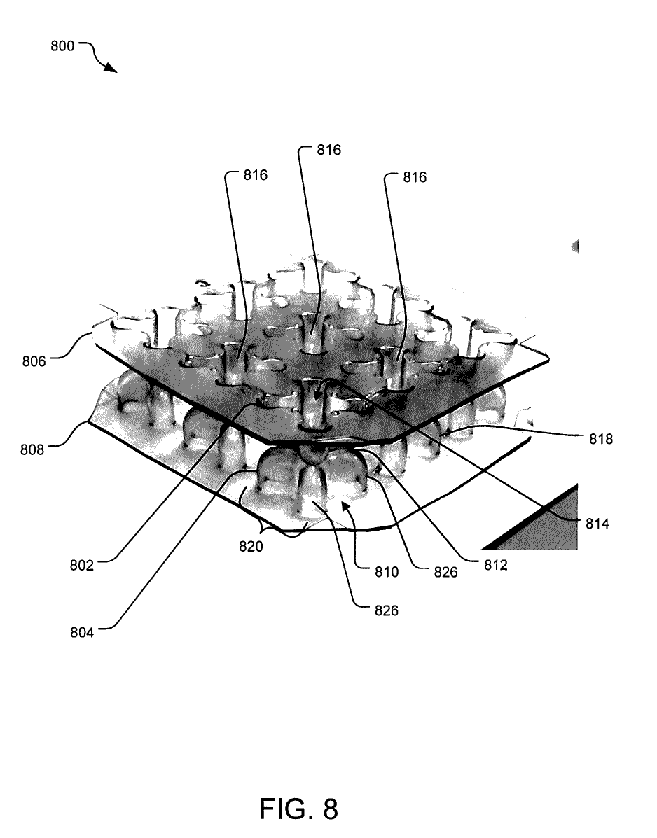

FIG. 8 illustrates a perspective view of an example cellular cushioning system 800 in an unloaded state. The cellular cushioning system 800 includes void cells (e.g., void cell 802 or void cell 804) arranged in two arrays. In other implementations, there can be one or more than two arrays of void cells.

For purposes of this disclosure, the two arrays in FIG. 1 are a top array 806 and a bottom array 808. However, in another implementation, the top array and bottom array could be referred to as right side and left side arrays, first and second arrays, bottom and top arrays, or other names features depending on desired terminology or configurations.

In FIG. 8, the top array 806 and the bottom array 808 have void cells (e.g., void cell 804), which comprise of four outwardly facing curvatures (e.g., curvature 810) in each sidewall (e.g., sidewall 820) of each void cell (e.g., void cell 804) in the top array 806 and the bottom array 808 in the cellular cushioning system 800. Each void cell (e.g., void cell 804) also comprise of eight inwardly facing curvatures (e.g., curvature 826), wherein two inwardly facing curvatures are each sidewall (e.g., sidewall 820) of each void cell.

In other implementations, there can be two, three, or more curvatures in each void cell. In some implementations, there may be more than one curvature in a sidewall of a void cell. In other implementations, there may be no curvature in one or more sidewalls.

Different numbers and patterns of outwardly facing curvatures (e.g., curvature 810) can be molded into the void cells (e.g., void cell 804) in an array. In some implementations, a square shape of a void cell (e.g., void cell 802) may adopt the slope of its twin square shape of an adjacent or adjoined void cell (e.g., void cell 804). In the cellular cushioning system 800, the peak or bottom (e.g., peak 812) of the void cell (e.g., void cell 804) can be significantly rounded or segmented as a result of a larger radius or of a deeper depth of each curvature (e.g., curvature 810), or by the number of curvatures present in each void cell.

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 11-13). Similarly, the opening or top (e.g., opening 814) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. Stiffness can be varied depending on the molding of these different patterns.

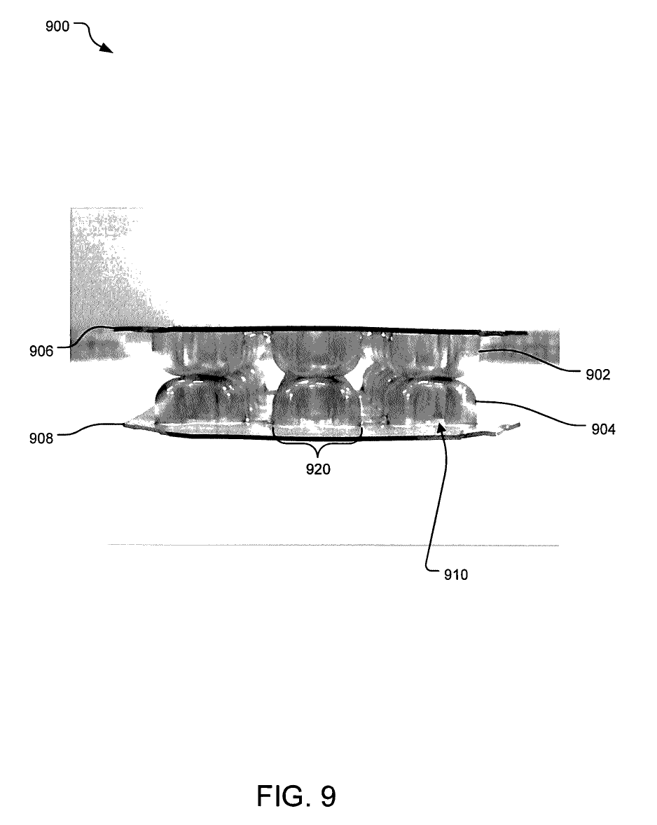

FIG. 9 illustrates an elevation view of the example cellular cushioning system in FIG. 1. The cellular cushioning system 900 includes void cells (e.g., void cell 902 or void cell 904) arranged in a top array 906 and a bottom array 908.

In FIG. 9, the top array 906 and the bottom array 908 have void cells (e.g., void cell 904), which comprise of four outwardly facing curvatures (e.g., curvature 910) in each sidewall 920 of each void cell in the top array 906 and the bottom array 908 in the cellular cushioning system 900.

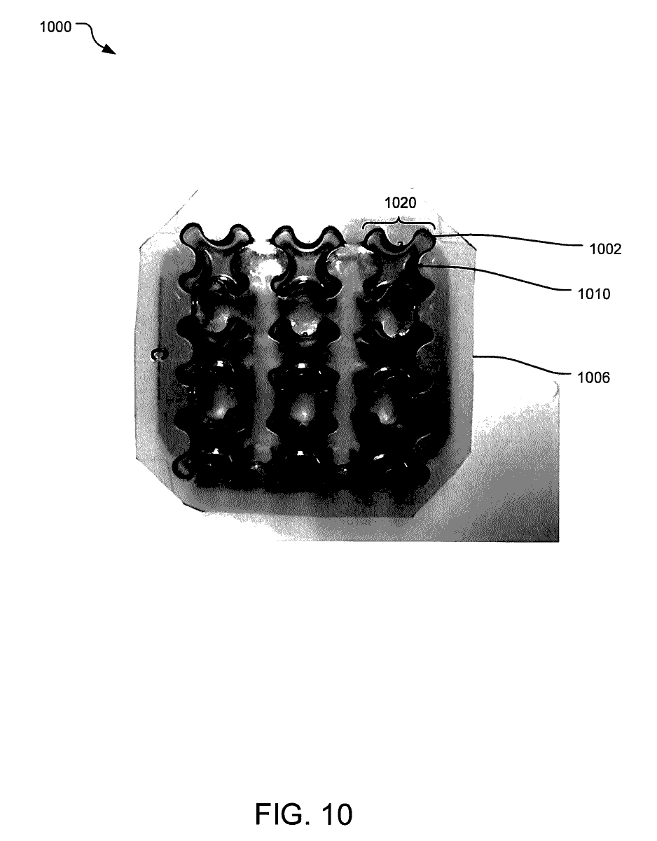

FIG. 10 illustrates a top view of the example cellular cushioning system in FIG. 1. As shown, the cellular cushioning system 1000 includes void cells (e.g., void cell 1002) arranged in a top array 1006 and a bottom array 1008 (not shown).

FIG. 10 shows the top array 1006 has void cells (e.g., void cell 1002), which comprise of four outwardly facing curvatures (e.g., curvature 1010) in each sidewall 1020 of each void cell in the top array 1006 in the cellular cushioning system 1000.

FIG. 11 illustrates a perspective view of an example cellular cushioning system 1100 in an unloaded state. The cellular cushioning system 1100 includes void cells (e.g., void cell 1102 or void cell 1104) arranged in two arrays. In other implementations, there can be one or more than two arrays of void cells.

For purposes of this disclosure, the two arrays in FIG. 11 are a top array 1106 and a bottom array 1108. However, in another implementation, the top array and bottom array could be referred to as right side and left side arrays, first and second arrays, bottom and top arrays, or other named features depending on desired terminology or configurations.

In FIG. 11, the top array 1106 and the bottom array 1108 have void cells (e.g., void cell 1104), which comprise of four outwardly facing curvatures (e.g., curvature 1110) in each sidewall (e.g., sidewall 1120) of each void cell (e.g., void cell 1104) in the top array 1106 and the bottom array 1108 in the cellular cushioning system 1100. Each void cell (e.g., void cell 1104) also comprise of eight inwardly facing curvatures (e.g., curvature 1126), wherein two inwardly facing curvatures are each sidewall (e.g., sidewall 1120) of each void cell.

In other implementations, there can be two, three, or more curvatures in each void cell. In some implementations, there may be more than one curvature in a sidewall of a void cell. In other implementations, there may be no curvature in one or more sidewalls.

Different numbers and patterns of outwardly facing curvatures(e.g., curvature 1110) can be molded into the void cells (e.g., void cell 1104) in an array. In some implementations, a square shape of a void cell (e.g., void cell 1102) may adopt the slope of its twin square shape of an adjacent or adjoined void cell (e.g., void cell 1104). In the cellular cushioning system 1100, the peak or bottom (e.g., peak 1112) of the void cell (e.g., void cell 1104) can be significantly rounded or segmented as a result of a larger radius or of a deeper depth of each curvature (e.g., curvature 1110), or by the number of curvatures present in each void cell.

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 11-13). Similarly, the opening or top (e.g., opening 1114) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. Stiffness can be varied depending on the molding of these different patterns.

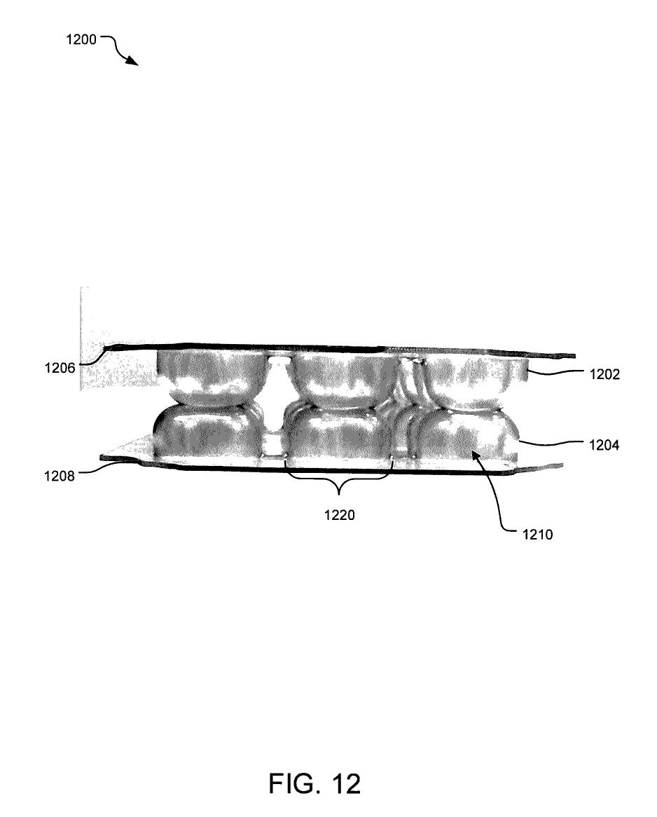

FIG. 12 illustrates an elevation view of the example cellular cushioning system in FIG. 1. The cellular cushioning system 1200 includes void cells (e.g., void cell 1202 or void cell 1204) arranged in a top array 1206 and a bottom array 1208.

In FIG. 12, the top array 1206 and the bottom array 1208 have void cells (e.g., void cell 1204), which comprise of four outwardly facing curvatures (e.g., curvature 1210) in each sidewall 1220 of each void cell in the top array 1206 and the bottom array 1208 in the cellular cushioning system 1200.

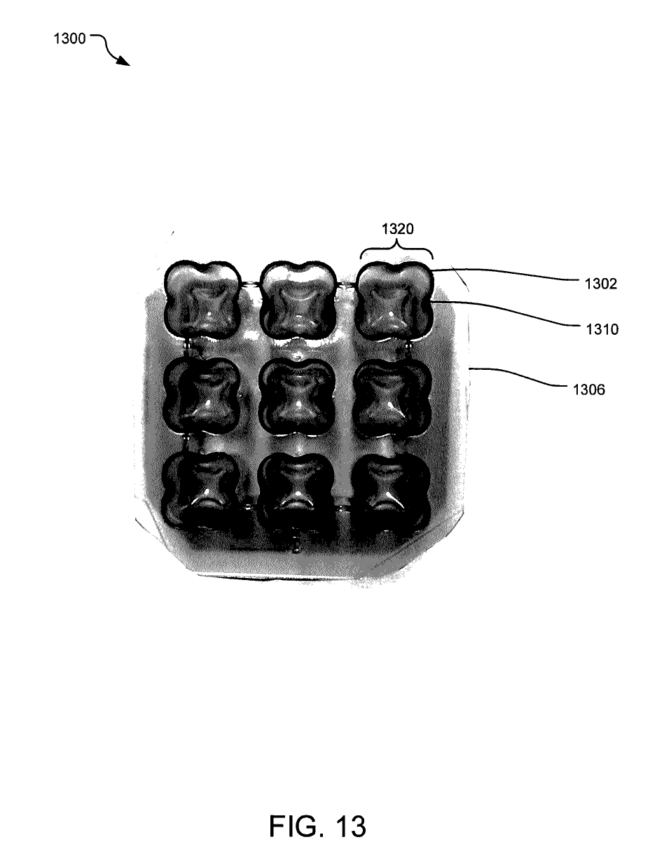

FIG. 13 illustrates a top view of the example cellular cushioning system in FIG. 1. As shown, the cellular cushioning system 1300 includes void cells (e.g., void cell 1302) arranged in a top array 1306 and a bottom array 1308 (not shown).

FIG. 13 shows the top array 1306 has void cells (e.g., void cell 1302), which comprise of four outwardly facing curvatures (e.g., curvature 1310) in each sidewall 1320 of each void cell in the top array 1306 in the cellular cushioning system 1300.

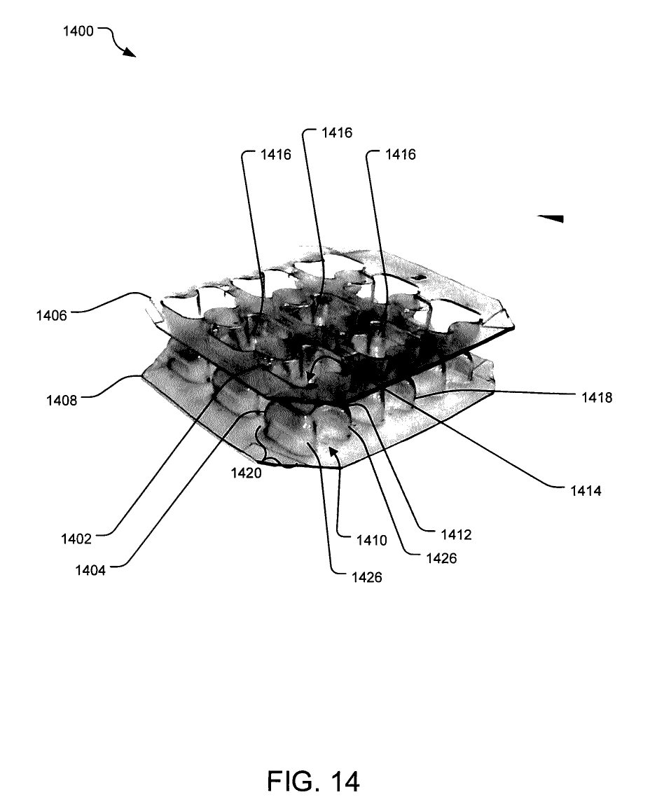

FIG. 14 illustrates a perspective view of an example cellular cushioning system 1400 in an unloaded state. The cellular cushioning system 1400 includes void cells (e.g., void cell 1402 or void cell 1404) arranged in two arrays. In other implementations, there can be one or more than two arrays of void cells.

For purposes of this disclosure, the two arrays in FIG. 14 are a top array 1406 and a bottom array 1408. However, in another implementation, the top array and bottom array could be referred to as right side and left side arrays, first and second arrays, bottom and top arrays, or other named features depending on desired terminology or configurations.

In FIG. 14, the top array 1406 and the bottom array 1408 have void cells (e.g., void cell 1404), which comprise of two outwardly facing curvatures (e.g., curvature 1410) on two opposing sidewalls (e.g., sidewall 1420) of each void cell (e.g., void cell 1404) in the top array 1406 and the bottom array 1408 in the cellular cushioning system 1400. Each void cell (e.g., void cell 1404) also comprise of four inwardly facing curvatures (e.g., curvature 1426), where the two inwardly facing curvatures are on two opposing each sidewalls (e.g., sidewall 1420) of each void cell.

In other implementations, there can be three or more curvatures in each void cell. In some implementations, there may be more than one curvature in a sidewall of a void cell. In other implementations, there may be no curvature in one or more sidewalls.

Different numbers and patterns of outwardly facing curvatures (e.g., curvature 1410) can be molded into the void cells (e.g., void cell 1404) in an array. In some implementations, a square shape of a void cell (e.g., void cell 1402) may adopt the slope of its twin square shape of an adjacent or adjoined void cell (e.g., void cell 1404). In the cellular cushioning system 1400, the peak or bottom (e.g., peak 1412) of the void cell (e.g., void cell 1404) can be significantly rounded or segmented as a result of a larger radius or of a deeper depth of each curvature (e.g., curvature 1410), or by the number of curvatures present in each void cell.

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 11-13). Similarly, the opening or top (e.g., opening 1414) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. Stiffness can be varied depending on the molding of these different patterns.

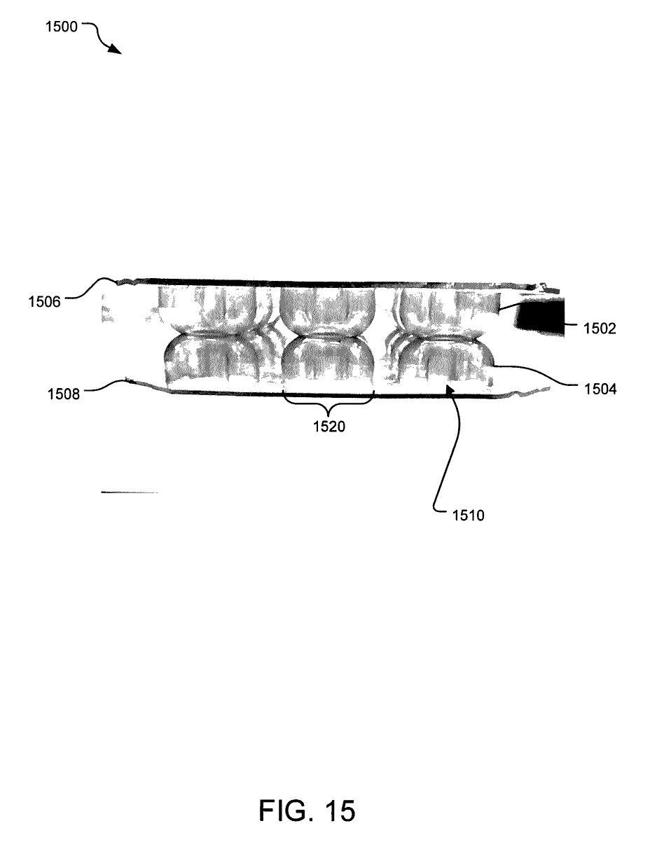

FIG. 15 illustrates an elevation view of the example cellular cushioning system in FIG. 1. The cellular cushioning system 1500 includes void cells (e.g., void cell 1502 or void cell 1504) arranged in a top array 1506 and a bottom array 1508.

In FIG. 15, the top array 1506 and the bottom array 1508 have void cells (e.g., void cell 1504), which comprise of four outwardly facing curvatures (e.g., curvature 1510) in each sidewall 1520 of each void cell in the top array 1506 and the bottom array 1508 in the cellular cushioning system 1500.

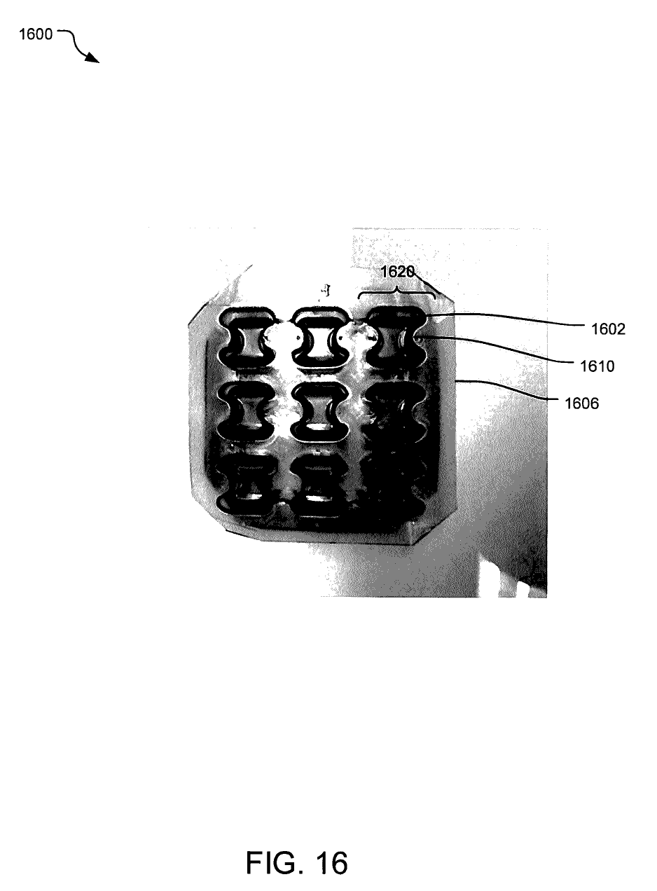

FIG. 16 illustrates a top view of the example cellular cushioning system in FIG. 1. As shown, the cellular cushioning system 1600 includes void cells (e.g., void cell 1602) arranged in a top array 1606 and a bottom array 1608 (not shown).

FIG. 16 shows the top array 1606 has void cells (e.g., void cell 1602), which comprise of four outwardly facing curvatures (e.g., curvature 1610) in each sidewall 1620 of each void cell in the top array 1606 in the cellular cushioning system 1600.

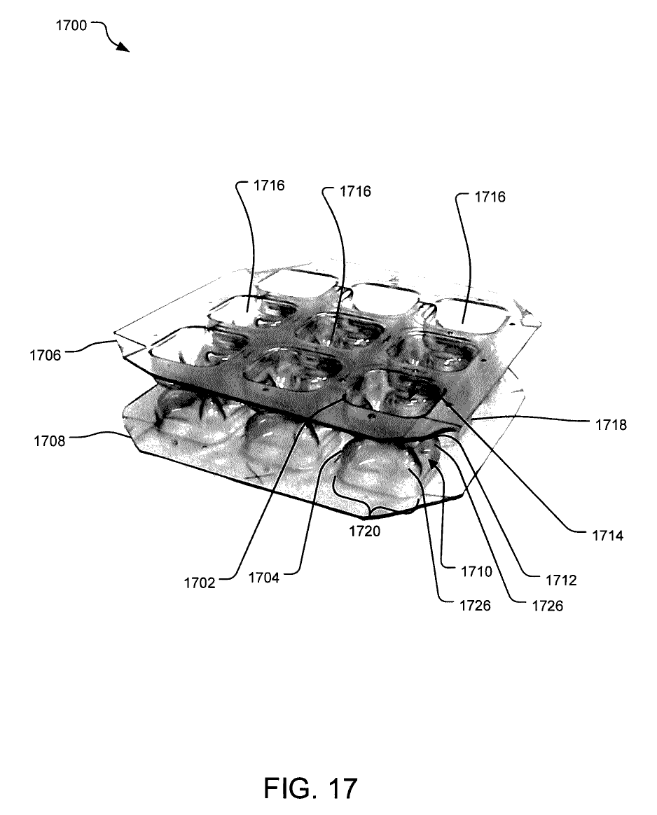

FIG. 17 illustrates a perspective view of an example cellular cushioning system 1700 in an unloaded state. The cellular cushioning system 1700 includes void cells (e.g., void cell 1702 or void cell 1704) arranged in two arrays. In other implementations, there can be one or more than two arrays of void cells.

For purposes of this disclosure, the two arrays in FIG. 17 are a top array 1706 and a bottom array 1708. However, in another implementation, the top array and bottom array could be referred to as right side and left side arrays, first and second arrays, bottom and top arrays, or other named features depending on desired terminology or configurations.

In FIG. 17, the top array 1706 and the bottom array 1708 have void cells (e.g., void cell 1704), which comprise of four outwardly facing curvatures (e.g., curvature 1710) in each sidewall (e.g., sidewall 1720) of each void cell (e.g., void cell 1704) in the top array 1706 and the bottom array 1708 in the cellular cushioning system 1700. Each void cell (e.g., void cell 1704) also comprise of eight inwardly facing curvatures (e.g., curvature 1726), wherein two inwardly facing curvatures are each sidewall (e.g., sidewall 1720) of each void cell.

In other implementations, there can be two, three, or more curvatures in each void cell. In some implementations, there may be more than one curvature in a sidewall of a void cell. In other implementations, there may be no curvature in one or more sidewalls.

Different numbers and patterns of outwardly facing curvatures (e.g., curvature 1710) can be molded into the void cells (e.g., void cell 1704) in an array. In some implementations, a square shape of a void cell (e.g., void cell 1702) may adopt the slope of its twin square shape of an adjacent or adjoined void cell (e.g., void cell 1704). In the cellular cushioning system 1700, the peak or bottom (e.g., peak 1712) of the void cell (e.g., void cell 1704) can be significantly rounded or segmented as a result of a larger radius or of a deeper depth of each curvature (e.g., curvature 1710), or by the number of curvatures present in each void cell.

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIGS. 11-13). Similarly, the opening or top (e.g., opening 1714) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. Stiffness can be varied depending on the molding of these different patterns.

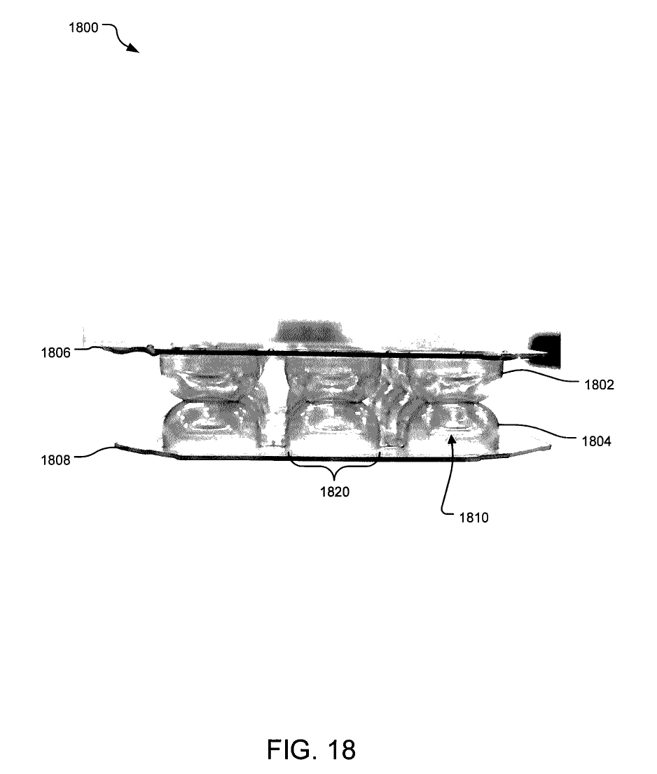

FIG. 18 illustrates an elevation view of the example cellular cushioning system in FIG. 1. The cellular cushioning system 1800 includes void cells (e.g., void cell 1802 or void cell 1804) arranged in a top array 1806 and a bottom array 1808.

In FIG. 18, the top array 1806 and the bottom array 1808 have void cells (e.g., void cell 1804), which comprise of four outwardly facing curvatures (e.g., curvature 1810) in each sidewall 1820 of each void cell in the top array 1806 and the bottom array 1808 in the cellular cushioning system 1800.

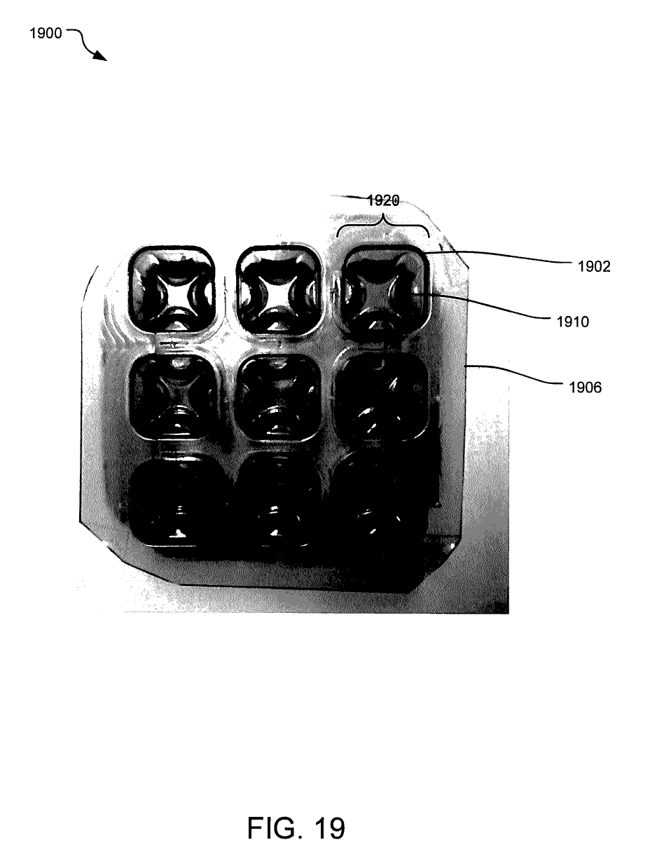

FIG. 19 illustrates a top view of the example cellular cushioning system in FIG. 1. As shown, the cellular cushioning system 1900 includes void cells (e.g., void cell 1902) arranged in a top array 1906 and a bottom array 1908 (not shown).

FIG. 19 shows the top array 1906 has void cells (e.g., void cell 1902), which comprise of four outwardly facing curvatures (e.g., curvature 1910) in each sidewall 1920 of each void cell in the top array 1906 in the cellular cushioning system 1900.

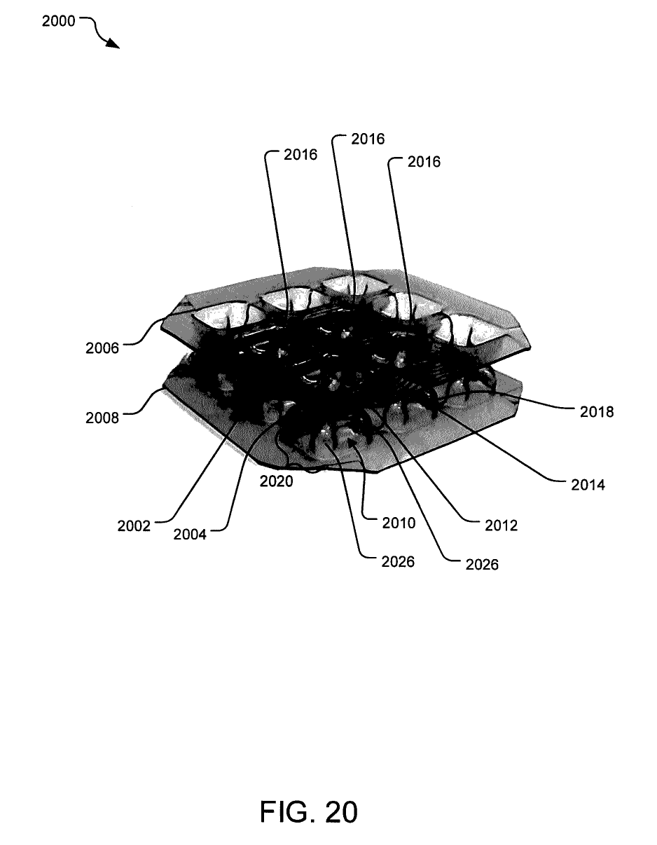

FIG. 20 illustrates a perspective view of an example cellular cushioning system 2000 in an unloaded state. The cellular cushioning system 2000 includes void cells (e.g., void cell 2002 or void cell 2004) arranged in two arrays. In other implementations, there can be one or more than two arrays of void cells.

For purposes of this disclosure, the two arrays in FIG. 20 are a top array 2006 and a bottom array 2008. However, in another implementation, the top array and bottom array could be referred to as right side and left side arrays, first and second arrays, bottom and top arrays, or other named features depending on desired terminology or configurations.

In FIG. 20, the top array 2006 and the bottom array 2008 have void cells (e.g., void cell 2004), which comprise of four outwardly facing curvatures (e.g., curvature 2010) in each sidewall (e.g., sidewall 2020) of each void cell (e.g., void cell 2004) in the top array 2006 and the bottom array 2008 in the cellular cushioning system 2000. Each void cell (e.g., void cell 2004) also comprise of eight inwardly facing curvatures (e.g., curvature 2026), wherein two inwardly facing curvatures are each sidewall (e.g., sidewall 2020) of each void cell.

In other implementations, there can be two, three, or more curvatures in each void cell. In some implementations, there may be more than one curvature in a sidewall of a void cell. In other implementations, there may be no curvature in one or more sidewalls.

Different numbers and patterns of outwardly facing curvatures (e.g., curvature 2010) can be molded into the void cells (e.g., void cell 2004) in an array. In some implementations, a square shape of a void cell (e.g., void cell 2002) may adopt the slope of its twin square shape of an adjacent or adjoined void cell (e.g., void cell 2004). In the cellular cushioning system 2000, the peak or bottom (e.g., peak 2012) of the void cell (e.g., void cell 2004) can be significantly rounded or segmented as a result of a larger radius or of a deeper depth of each curvature (e.g., curvature 2010), or by the number of curvatures present in each void cell.

In other implementations, the peak or bottom of a void cell can be less rounded or segmented as a result of a smaller radius or of a shallower depth of each curvature, or by the number of curvatures present in each void cell (See, for example, the less rounded and segmented peak of the void cells with the smaller radius of curvatures and smaller number of curvatures in FIG. 11-13). Similarly, the opening or top (e.g., opening 2014) of the void cell can vary in shape as a result of a smaller radius or of a shallower depth of each curvature, or by the number of curvatures present in each void cell.

In other implementations, curvatures can be molded only near the planar surface, halfway up a void cell, or close to the joints of void cells. The elastic modulus of the cells can be varied depending on the molding of these different patterns.

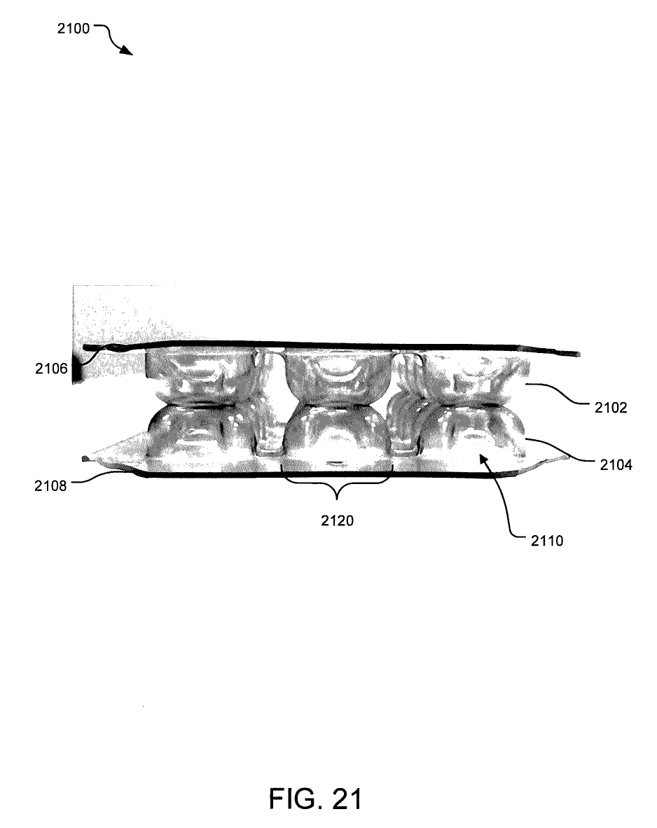

FIG. 21 illustrates an elevation view of the example cellular cushioning system in FIG. 1. The cellular cushioning system 2100 includes void cells (e.g., void cell 2102 or void cell 2104) arranged in a top array 2106 and a bottom array 2108.

In FIG. 21, the top array 2106 and the bottom array 2108 have void cells (e.g., void cell 2104), which comprise of four outwardly facing curvatures (e.g., curvature 2110) in each sidewall 2120 of each void cell in the top array 2106 and the bottom array 2108 in the cellular cushioning system 2100.

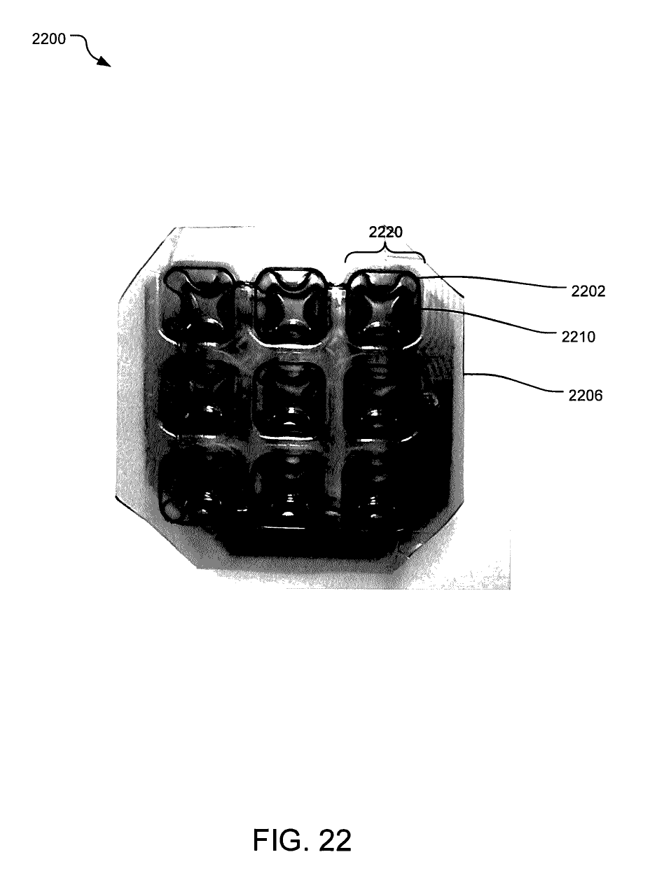

FIG. 22 illustrates a top view of the example cellular cushioning system in FIG. 1. As shown, the cellular cushioning system 2200 includes void cells (e.g., void cell 2202) arranged in a top array 2206 and a bottom array 2208 (not shown).

FIG. 22 shows the top array 2206 has void cells (e.g., void cell 2202), which comprise of four outwardly facing curvatures (e.g., curvature 2210) in each sidewall 2220 of each void cell in the top array 2206 in the cellular cushioning system 2200.

FIG. 23 shows a graph 2300 of force displacement of void cells in an array of the described cushioning system. The lines on the graph show force displacement curves based on Displacement (mm)×Load (N). The “Twin Squares” line correlates to an array of void cells with no outwardly facing curvatures. The lines A-G correlate to the void cells in the arrays as follows:

Line A correlates to FIGS. 1, 3, and 4

Line B correlates to FIGS. 5, 6, and 7

Line C correlates to FIGS. 8, 9, and 10

Line D correlates to FIGS. 11, 12, and 13

Line E correlates to FIGS. 14, 15, and 16

Line F correlates to FIGS. 17, 18, and 19

Line G correlates to FIGS. 20, 21, and 22

As shown in the graph, it takes a different amount of force to obtain the same amount of displacement depending on the presences and configuration of outwardly facing curvatures in the sides of the void cells. For example, lines B and D, which both represent configurations comprising four outwardly facing curvatures in the sides of each void cell almost trace each other in force displacement, and then diverge between 11 and 12 mm displacement. As radiuses are introduced into the void cells, splits are visible on the graph of two lines, which were almost the same. Line C shows a configuration with an easy compression, then shows a higher elastic modulus as displacement increases. Line B has the same slope as line C but progresses to show the higher elastic modulus of the void cells of the configuration represented. Compared to that, line G has relatively even compression (similar to foam), and then stiffens up. Forming the radiuses in the curvatures of the void cell results in a 40% reduction of impact and compression.

FIG. 24 shows a table 2400 of load force based on 10%, 25%, 50%, and 75% compression for the void cells in arrays of the described cushioning systems. The “TS” (twin squares) configuration data correlates to an array of void cells with no outwardly facing curvatures. The configurations A-G correlate to the void cells in the arrays as follows:

Configuration A correlates to FIGS. 1, 3, and 4

Configuration B correlates to FIGS. 5, 6, and 7

Configuration C correlates to FIGS. 8, 9, and 10

Configuration D correlates to FIGS. 11, 12, and 13

Configuration E correlates to FIGS. 14, 15, and 16

Configuration F correlates to FIGS. 17, 18, and 19

Configuration G correlates to FIGS. 20, 21, and 22

The data in the table 2400 shows an increase in load force (N) results in greater measurements of compression. For example, a load force of 1214 N for Configuration G, results in 75% compression, whereas a load force of only 376 N results in only 10% compression for Configuration G.

The array configuration with only two outwardly facing curvatures in each void cell (Configuration E) requires a lower load force N (see load force of 1168N for 75% compression) as compared to configurations with four outwardly facing curvatures in each void cell (Configurations A-D and F-G), which require load forces of 1214N and above for 75% compression. The array configuration with no outwardly facing curvatures in each void cell (Configuration TS) requires an even lower load force N of 855N for 75% compression as compared to the configuration with two outwardly facing curvatures in each void cell (Configurations E).

Photographs of the void cells measured and depicted in the graph shown in FIG. 23 and the table in FIG. 24 are attached in an Appendix. The Appendix includes photographs for Configurations TS and A-G (described in FIGS. 23-24) at 10% compression, 25% compression, 50% compression, 75% compression, a side unloaded view, a side view, and a top view.

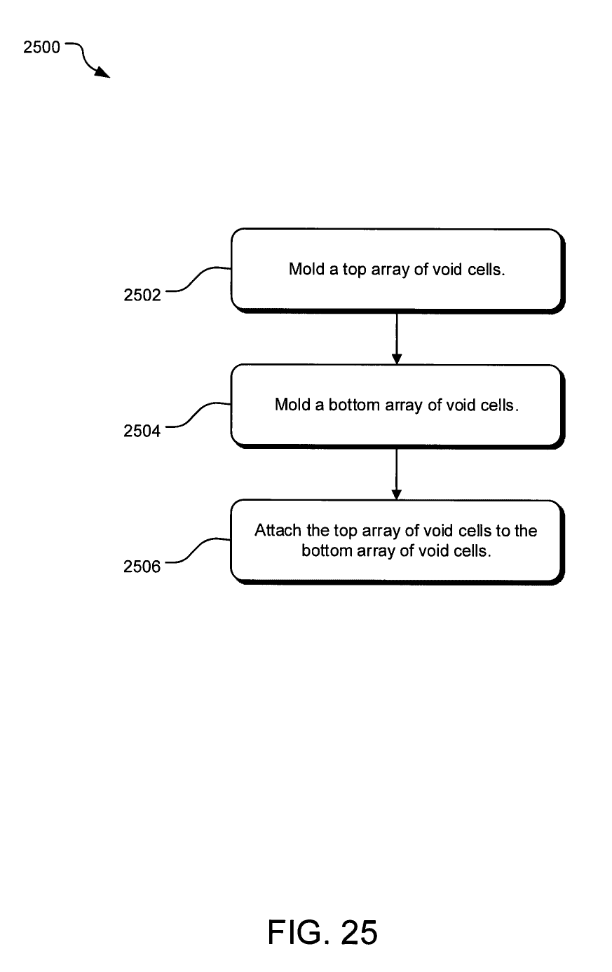

FIG. 25 illustrates example operations 2500 for manufacturing a cellular cushioning system. The cellular cushioning system may be molded, or in other implementations manufactured using a variety of manufacturing processes (e.g., blow molding, thermoforming, extrusion, injection molding, laminating, etc.). The cushioning system can comprise of one or more arrays of void cells. The arrays can be flat (planar) or curved (non-planar).

A first molding operation 2502 molds a top array of void cells. The void cells in the top array comprise of one or more inwardly facing curvatures and one or more outwardly facing curvatures. Each curvature is configured in a sidewall of a void cell.

A second molding operation 2504 molds a bottom array of void cells. The void cells in the bottom array comprise of one or more inwardly facing curvatures and one or more outwardly facing curvatures. Each curvature is configured in a sidewall of a void cell.

The arrays can be molded to each other or attached by other means. The void cells are hollow chambers that resist deflection due to compressive forces, similar to compression springs. At least the material, wall thickness, size, and shape of each of the void cells define the resistive force each of the void cells can apply. Materials used for the void cells are generally elastically deformable under expected load conditions and will withstand numerous deformations without fracturing or suffering other breakdown impairing the function of the cellular cushioning system. Example materials include thermoplastic urethane, thermoplastic elastomers, styrenic co-polymers, rubber, Dow Pellethane®, Lubrizol Estane®, Dupont™ Hytrel®, ATOFINA Pebax®, and Krayton polymers. Further, the wall thickness may range from 5 mil to 80 mil. Still further, the size of each of the void cells may range from 5 mm to 70 mm sides in a cubical implementation. Further yet, the void cells may be cubical, pyramidal, hemispherical, or any other shape with external facing curvature capable of having a hollow interior volume. Other shapes may have similar dimensions as the aforementioned cubical implementation. Still further, the void cells may be spaced a variety of distances from one another. An example spacing range is 2.5 mm to 150 mm.

In one implementation, the void cells have a square or rectangular base shape, with a trapezoidal volume and a rounded top. That void cell geometry may provide a smooth compression profile of the system and minimal bunching of the individual void cells. Bunching occurs particularly on corners and vertical sidewalls of the void cells where the material buckles in such a way as to create multiple folds of material that can cause pressure points and a less uniform feel to the cellular cushioning system overall.

An attaching operation 2506 attaches the top array of void cells and the bottom array of void cells together. The two arrays can be laminated, glued, or otherwise attached together at the peaks of the void cells in the top array and the bottom array.

Due to varying configurations with a different number of void cells in the two arrays, the attachment of the void cells to each other may occur at different points of contact on each void cell.

Each void cell can be surrounded by neighboring void cells within an array. For example, each void cell is surrounded by three neighboring void cells within the top array. In the cellular cushioning system, there are three neighboring void cells for each corner void cell, five neighboring void cells for each edge cell, and eight neighboring void cells for the rest of the void cells. Other implementations may have greater or fewer neighboring void cells for each void cell. Further, each void cell has a corresponding opposing void cell within an opposite array. For example, each void cell in the top array is opposed by a void cell in the bottom array. Other implementations do not include opposing void cells for some or all of the void cells. Still further, each void cell has corresponding neighbor opposing cells within an opposite array. For example, each void cell in the top array has corresponding neighbor opposing cells in the bottom array. The neighbor opposing cells are opposing void cells for each neighboring void cell of a particular void cell.

The neighboring void cells, opposing void cells, and neighbor opposing void cells are collectively referred to herein as adjacent void cells. In various implementations, one or more of the neighboring void cells, opposing void cells, and opposing neighbor void cells are not substantially compressed within an independent compression range of an individual void cell.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet other embodiments without departing from the recited claims.

What is claimed is:

1. A cushioning structure comprising:
a first array of void cells, wherein each void cell includes both outwardly curved surfaces and inwardly curved surfaces, and wherein the outwardly curved surfaces constitute a substantial portion of the overall exterior surface area of each void cell.

2. The cushioning structure of claim 1, further comprising:
a second array of void cells, wherein peak surfaces of peak portions of void cells in the second array of void cells are attached to peak surfaces of peak portions of void cells in the first array.

3. The cushioning structure of claim 1, wherein a perimeter length substantially exceeds an overall outline length of a base portion of each void cell.

4. The cushioning structure of claim 1, wherein an outwardly curved surface depth substantially recesses from an overall outline of a base portion of each void cell.

5. The cushioning structure of claim 1, wherein each void cell is open to atmosphere.

6. The cushioning structure of claim 1, wherein each void cell includes:
a base portion that includes only the inwardly curved surfaces; and
a peak portion that includes both the outwardly curved surfaces and the inwardly curved surfaces.

7. The cushioning structure of claim 1, wherein each void cell includes a dome-shaped peak portion.

8. The cushioning structure of claim 1, wherein an overall outline of a base portion of each void cell is rectangular, and wherein radii of the outwardly curved surfaces are less than both half a length and half a width of the rectangular overall outline of the base portion.

9. An energy absorbing void cell comprising:
a base portion that includes inwardly curved surfaces; and
a peak portion that includes both outwardly curved surfaces and inwardly curved surfaces, wherein the outwardly curved surfaces constitute a substantial portion of the overall exterior surface area of the void cell.

10. The energy absorbing void cell of claim 9, wherein a perimeter length substantially exceeds an overall outline length of a base portion of the void cell.

11. The energy absorbing void cell of claim 9, wherein an outwardly curved surface depth substantially recesses from an overall outline of a base portion of the void cell.

12. The energy absorbing void cell of claim 9, wherein the void cell is open to atmosphere.

13. The energy absorbing void cell of claim 9, wherein each of peak portion of a void cell includes a dome-shaped peak surface.

14. The energy absorbing void cell of claim 9, wherein an overall outline of a base portion of the void cell is rectangular, and wherein radii of the outwardly curved surfaces are less than both half a length and half a width of the rectangular overall outline of the base portion.

15. A method of manufacturing a cellular cushioning system comprising:
molding a first array of void cells, wherein each void cell includes both outwardly curved surfaces and inwardly curved surfaces, and wherein the outwardly curved surfaces constitute a substantial portion of the overall exterior surface area of each void cell;
molding a second array of void cells, wherein each void cell includes both outwardly curved surfaces and inwardly curved surfaces, and wherein the outwardly curved surfaces constitute a substantial portion of the overall exterior surface area of each void cell; and
attaching peak surfaces of peak portions of void cells in the first array of void cells to peak surfaces of peak portions of void cells in the second array of void cells.

16. The method of claim 15, wherein a perimeter length substantially exceeds an overall outline length of a base portion of each molded void cell.

17. The method of claim 15, wherein an outwardly curved surface depth substantially recesses from an overall outline of a base portion of each molded void cell.

18. The method of claim 15, wherein each molded void cell is open to atmosphere.

19. The method of claim 15, wherein each molded void cell includes:
a base portion that includes only the inwardly curved surfaces; and
a peak portion that includes both the outwardly curved surfaces and the inwardly curved surfaces.

20. The method of claim 15, wherein each peak portion of a molded void cell includes a dome-shaped peak surface.

21. The method of claim 15, wherein an overall outline of a base portion of each molded void cell is rectangular, and wherein radii of the outwardly curved surfaces are less than both half a length and half a width of the rectangular overall outline of the base portion.
